(19) United States
(12) Patent Application Publication
(10) Pub. No.: US 2020/0261313 A1
(43) Pub. Date: Aug. 20, 2020

(54) FLUID BAG INCLUDING A PRESSING BAG HAVING PLURALITY OF UNIT SPACES

(71) Applicant: Moung Sook LEE, Anyang-si (KR)

(72) Inventor: Moung Sook LEE, Anyang-si (KR)

(21) Appl. No.: 16/487,476

(22) PCT Filed: Mar. 25, 2019
(86) PCT No.: PCT/KR2019/003463

§ 371 Date: Aug. 21, 2019

(30) Foreign Application Priority Data
Jan. 30, 2019 (KR) 10-2019-0012180

(51) Int. Cl. A61J 1/10; B65D 83/00; A61J 1/14

(52) U.S. Cl. CPC A61J 1/10; A61J 1/14; B65D 83/0061

(57) ABSTRACT

Disclosed is a fluid bag including a main body having a fluid storage space capable of containing a fluid, an air storage space capable of containing air, and a pressing bag capable of inflating to press the main body when the air storage space is filled with the air, wherein the pressing bag is integrally connected to the main body, and wherein the air storage space includes one or more unit spaces connected to each other and spatially divided by boundary lines. According to the present invention, the main body may be pressed within a short time without excessively inflating the pressing bag, and a user may not feel anxious that the pressing bag would excessively inflate and burst.

### TECHNICAL FIELD

The present invention relates to a fluid bag, and more particularly, to a fluid bag capable of pressing a main body storing a fluid, within a short time without excessively inflating a pressing bag.

### BACKGROUND ART

A fluid is a sort of medical liquid to be administered into a human body to treat a shock, dehydration, or malnutrition, and includes blood and various electrolyte solutions isotonic with blood, e.g., a physiological saline and a Ringer's solution.

The fluid is a medical liquid to be administered through a vein of a patient for an operation or therapy or to treat a shock, dehydration, or malnutrition, and includes, for example, blood, an electrolyte solution, and a medicine similar to blood and, more specifically, a physiological saline, a Ringer's solution, a parenteral nutrition solution, and an intravenous fluid which are isotonic with human body fluids.

As a conventional medicine administration device for supplying the fluid, a fluid bag is hanged upside down above a human body and a medicine is administered into the human body through a tube and a needle connected to the fluid bag.

For example, a large quantity of medicine needs to be rapidly administered to a surgical patient at an accurate flow rate with an accurate dose, but the conventional medicine administration device may not easily achieve such a goal.

To solve this problem, a piston-type medicine administration device, a syringe-type medicine administration device, etc. have been developed. However, such medicine administration devices are easily broken due to complex structures thereof and have high total manufacturing costs.

An example of the medicine administration devices is disclosed in Korean Patent Publication No. 2003-0095847 published on Dec. 24, 2003.

FIG. 2 of the patent publication discloses that air compressed based on the principle of a piston 2 by putting a weight 1 in a cylinder is delivered through a tube 3 to increase an internal pressure of a cuff 4 located to surround a fluid bag and capable of being filled with air to inflate, and the inflated cuff 4 squeezes the fluid bag.

However, the cuff 4 disclosed in the patent publication is a sort of a device for pressing the upper arm to measure a blood pressure, and a medical person needs to put the fluid bag into the cuff 4 or wind the cuff 4 around the fluid bag.

Thus, a medicine administration procedure may be complicated and an emergency patient may not be rapidly treated.

In addition, because the cuff 4 is reused several times, a risk of medical accidents such as cross contamination when a medical person mounts the fluid bag in the cuff 4 may be high.

### DETAILED DESCRIPTION OF THE INVENTION

### Technical Problem

The present invention provides a fluid bag improved in structure to press a main body storing a fluid, within a short time without excessively inflating a pressing bag.

### Technical Solution

According to an aspect of the present invention, there is provided a fluid bag including a main body having a fluid storage space capable of containing a fluid, an air storage space capable of containing air, and a pressing bag capable of inflating to press the main body when the air storage space is filled with the air, wherein the pressing bag is integrally connected to the main body, and wherein the air storage space includes one or more unit spaces connected to each other and spatially divided by boundary lines.

The air storage space may be formed by association of an outer surface of the main body and an inner surface of the pressing bag, and the boundary lines may be formed by bonding the outer surface of the main body to the inner surface of the pressing bag.

A fluid outlet connected to the fluid storage space may be provided at a lower end of the main body, the one or more unit spaces may be arranged from an upper end of the pressing bag to a lower end of the pressing bag, and the unit spaces may be filled with the air and inflate sequentially from the unit space located at the upper end of the pressing bag to the unit space located at the lower end of the pressing bag.

A plurality of the boundary lines may extend along a second central axis crossing a virtual first central axis extending from the upper end of the pressing bag to the lower end of the pressing bag, and may be spaced apart from each other by a preset distance and be arranged along the first central axis.

A flow rate reducer for disturbing flow of the air may be provided between neighboring unit spaces to control a flow rate of the air per unit time to be equal to or less than a preset value.

### Advantageous Effects of the Invention

According to the present invention, a fluid bag includes a main body having a fluid storage space capable of containing a fluid, an air storage space capable of containing air, and a pressing bag capable of inflating to press the main body when the air storage space is filled with the air, wherein the pressing bag is integrally connected to the main body, and wherein the air storage space includes one or more unit spaces connected to each other and spatially divided by boundary lines. Thus, the main body may be pressed within a short time without excessively inflating the pressing bag, and a user may not feel anxious that the pressing bag would excessively inflate and burst.

### DESCRIPTION OF THE DRAWINGS

FIG. 1 is a schematic diagram of a fluid bag according to an embodiment of the present invention.

FIG. 2 is a cross-sectional view taken along line A-A of the fluid bag illustrated in FIG. 1.

FIG. 3 is a cross-sectional view taken along line B-B of the fluid bag illustrated in FIG. 1.

FIG. 4 is a cross-sectional view showing an inflated state of a pressing bag of the fluid bag illustrated in FIG. 1.

FIG. 5 is a schematic diagram of a fluid bag according to another embodiment of the present invention.

FIG. 6 is a cross-sectional view taken along line Al-Al of the fluid bag illustrated in FIG. 5.

FIG. 7 is a cross-sectional view taken along line C-C of the fluid bag illustrated in FIG. 5.

FIG. 8 is a cross-sectional view taken along line D-D of the fluid bag illustrated in FIG. 5.

FIG. 9 is a magnified view of part E of the fluid bag illustrated in FIG. 5.

### BEST MODE

Hereinafter, the present invention will be described in detail by explaining embodiments of the invention with reference to the attached drawings.

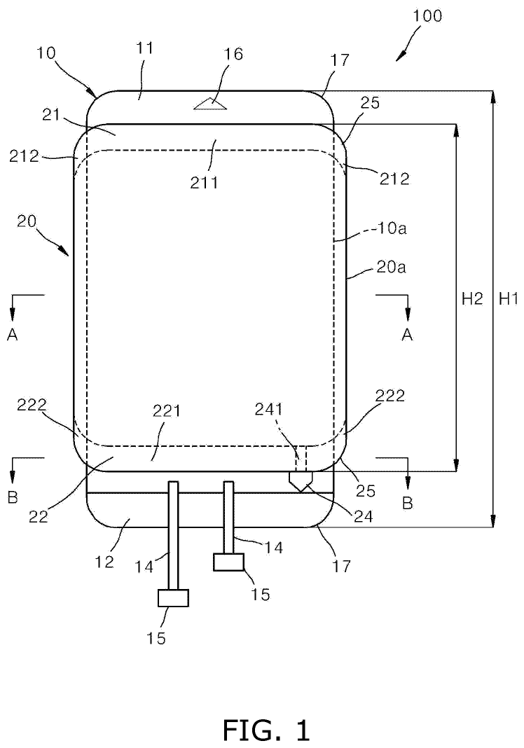

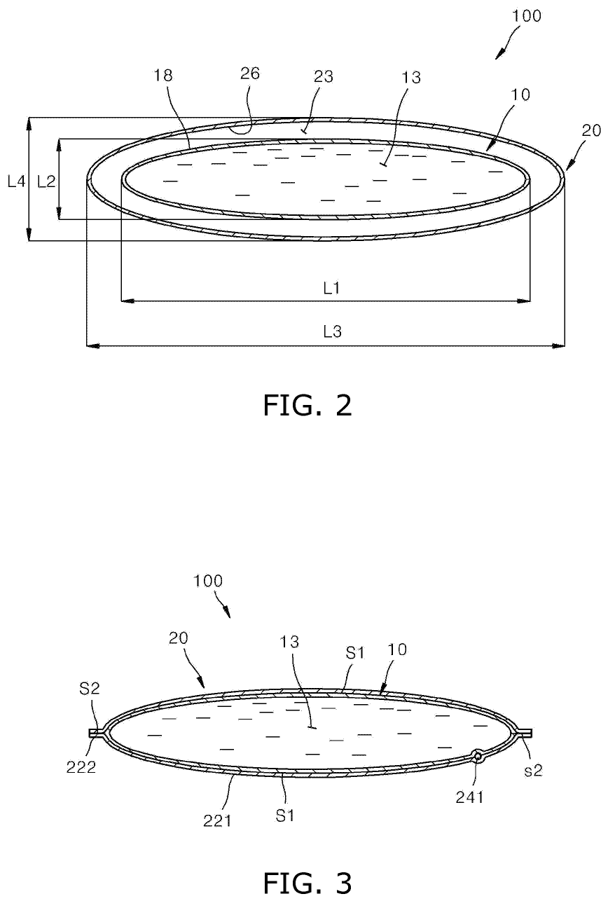

FIG. 1 is a schematic diagram of a fluid bag 100 according to an embodiment of the present invention, and FIG. 2 is a cross-sectional view taken along line A-A of the fluid bag 100 illustrated in FIG. 1.

Referring to FIGS. 1 and 2, the fluid bag 100 according to an embodiment of the present invention is a container of a medical fluid to be administered into a human body, and includes a main body 10 and a pressing bag 20.

Herein, the fluid is a medical liquid to be administered through a vein of a patient for an operation or therapy or to treat a shock, dehydration, or malnutrition, and includes, for example, blood, an electrolyte solution, and a medicine similar to blood and, more specifically, a physiological saline, a Ringer's solution, a parenteral nutrition solution, and an intravenous fluid which are isotonic with human body fluids.

The main body 10 is a bag-shaped container capable of containing the fluid, and is produced using a thin synthetic resin film.

The main body 10 may be produced using a flexible film made of, for example, a polystyrene-based, polyolefin-based, polyurethane-based, or polyester-based material, or vinyl chloride.

In the current embodiment, the main body 10 is produced using a polyethylene film having a thickness of 180 μm to 350 μm and, more specifically, of 220 μm to 320 μm.

The main body 10 has a preset height H1, and is provided in a flat shape having a width L1 greater than a depth L2 as illustrated in FIG. 2.

In the current embodiment, the main body 10 is formed by sealing, with a first seal 11 and a second seal 12, both ends of a pipe-shaped member 10a having a first hollow space 13.

In the current embodiment, the first hollow space 13, upper and lower ends of which are sealed, serves as a fluid storage space 13 capable of containing the fluid.

The first seal 11 is provided at an upper end of the main body 10, and the second seal 12 is provided at a lower end of the main body 10.

The first and second seals 11 and 12 are formed in an airtight manner by bonding parts of an inner surface of the main body 10 to each other based on thermal welding.

A hanging hole 16 having a triangle shape is provided at the center of the first seal 11.

A fluid outlet 14 is provided at the lower end of the main body 10. The fluid outlet 14 is a tube-shaped member used to discharge the fluid stored in the fluid storage space 13.

A cap 15 capable of sealing the fluid outlet 14 is mounted at an end of the fluid outlet 14.

The cap 15 is formed in such a manner that a spike (not shown) connected to a drip chamber (not shown) may be inserted thereinto, and is well known to one of ordinary skill in the art and thus will not be described in detail herein.

Round parts 17 having an arc shape are provided at four corners of the main body 10 as illustrated in FIG. 1.

The pressing bag 20 is a bag-shaped container capable of being filled with air G to inflate and press the main body 10, and is produced using a thin synthetic resin film.

Like the main body 10, the pressing bag 20 may be produced using a flexible film made of polyolefin-based resin.

In the current embodiment, like the main body 10, the pressing bag 20 is produced using a polyethylene film having a thickness equal to the thickness of as the main body 10.

The pressing bag 20 is provided in a flat shape having a width L3 greater than a depth L4 as illustrated in FIG. 2.

In the current embodiment, the pressing bag 20 is formed by sealing, with a third seal 21 and a fourth seal 22, both ends of a pipe-shaped member 20a having a second hollow space 23.

In the current embodiment, the second hollow space 23, upper and lower ends of which are sealed, serves as an air storage space 23 capable of containing air.

The pressing bag 20 is provided ata middle part of the main body 10, and has a height H2 less than the height H1 of the main body 10 such that the upper and lower ends of the main body 10 are exposed.

In the current embodiment, the middle part of the main body 10 is accommodated in the second hollow space 23 as illustrated in FIG. 2, and the air storage space 23 is formed by association of an outer surface 18 of the main body 10, an inner surface 26 of the pressing bag 20, and the third and fourth seals 21 and 22 as illustrated in FIGS. 1 and 2.

An air inlet 24 connected to the air storage space 23 is provided at a lower end of the pressing bag 20.

The third seal 21 is provided at an upper end of the pressing bag 20, and the fourth seal 22 is provided at the lower end of the pressing bag 20.

The third and fourth seals 21 and 22 are formed in an airtight manner based on thermal welding.

The third seal 21 includes a horizontal part 211 extending in a horizontal direction, and an end part 212 provided at both ends of the horizontal part 211.

The horizontal part 211 includes a first bonded surface S1 formed by thermally welding the inner surface 26 of the pressing bag 20 to the outer surface 18 of the main body 10, similarly to the illustration of FIG. 3.

The end part 212 includes a second bonded surface S2 formed by thermally welding parts of the inner surface 26 of the pressing bag 20 to each other, similarly to the illustration of FIG. 3.

The fourth seal 22 includes a horizontal part 221 extending in a horizontal direction, and an end part 222 provided at both ends of the horizontal part 221.

The horizontal part 221 includes a first bonded surface S1 formed by thermally welding the inner surface 26 of the pressing bag 20 to the outer surface 18 of the main body 10, as illustrated in FIG. 3.

The end part 222 include a second bonded surface S2 formed by thermally welding parts of the inner surface 26 of the pressing bag 20 to each other, as illustrated in FIG. 3.

A passage 241 for connecting the air storage space 23 to the air inlet 24 is provided in the horizontal part 221.

Round parts 25 having an arc shape are provided at four corners of the pressing bag 20 as illustrated in FIG. 1.

The end parts 212 and 222 are provided in a sawtooth or claw shape corresponding to the shape of the round parts 25, to increase airtightness and adhesion of the pressing bag 20 when the pressing bag 20 inflates.

When the end parts 212 and 222 are provided in the sawtooth or claw shape as described above, stress concentration near the end parts 212 and 222 may be prevented.

In the current embodiment, the third and fourth seals 21 and 22 are provided in mutually corresponding or equal shapes except for the passage 241.

Therefore, the pressing bag 20 is integrally connected to the main body 10 by the third and fourth seals 21 and 22.

An example of a method of using the above-described fluid bag 100 will now be described. Initially, before the air storage space 23 of the pressing bag 20 is filled with the air, the pressing bag 20 does not inflate as illustrated in FIG. 2.

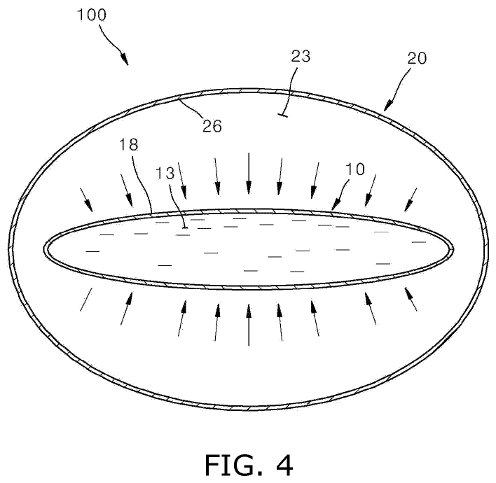

When an air pump (not shown) is connected to the air inlet 24 and then is driven, the air is filled in the air storage space 23 and the pressing bag 20 inflates as illustrated in FIG. 4.

Herein, the air pump (not shown) may include various air pumps such as a piston air pump and an electric air pump, and thus a detailed description thereof will not be provided herein.

When an air pressure in the air storage space 23 increases, the main body 10 is squeezed by the air pressure as illustrated in FIG. 4, and the fluid stored in the fluid storage space 13 of the main body 10 is ready to be discharged through the fluid outlet 14 due to the difference between an external air pressure and a pressure of the fluid stored in the main body 10.

The fluid discharged through the fluid outlet 14 passes through the cap 15 and the drip chamber (not shown) and is administered into a human body.

The above-described fluid bag 100 includes the main body 10 having the fluid storage space 13 capable of containing the fluid, the air storage space 23 capable of containing the air, and the pressing bag 20 capable of inflating to press the main body 10 when the air storage space 23 is filled with the air, wherein the pressing bag 20 is integrally connected to the main body 10. Thus, unlike conventional cases, a procedure for mounting a fluid bag in a pressing device by a medical person is not required such that an emergency patient may be rapidly treated and a risk of medical accidents such as cross contamination may be prevented.

In the fluid bag 100, the main body 10 is formed by sealing the both ends of the pipe-shaped member 10a having the first hollow space 13, the sealed first hollow space 13 serves as the fluid storage space 13, the pressing bag 20 is formed by sealing the both ends of the pipe-shaped member 20a having the second hollow space 23, at least a part of the main body 10 is accommodated in the second hollow space 23, and the air storage space 23 is formed by association of the outer surface 18 of the main body 10 and the inner surface 26 of the pressing bag 20. Thus, the main body 10 may be easily integrated with the pressing bag 20, an overall product volume may be reduced, and the pressing bag 20 may efficiently press the main body 10.

Furthermore, in the fluid bag 100, the pressing bag 20 is provided at the middle part of the main body 10 and the upper and lower ends of the main body 10 are exposed. Thus, the hanging hole 16 and the fluid outlet 14 may be easily formed.

Besides, in the fluid bag 100, the hanging hole 16 is provided at the upper end of the main body 10 and the fluid outlet 14 is provided at the lower end of the main body 10. Thus, the fluid bag 100 with the fluid outlet 14 facing downward may be hanged on a separate stand or the like.

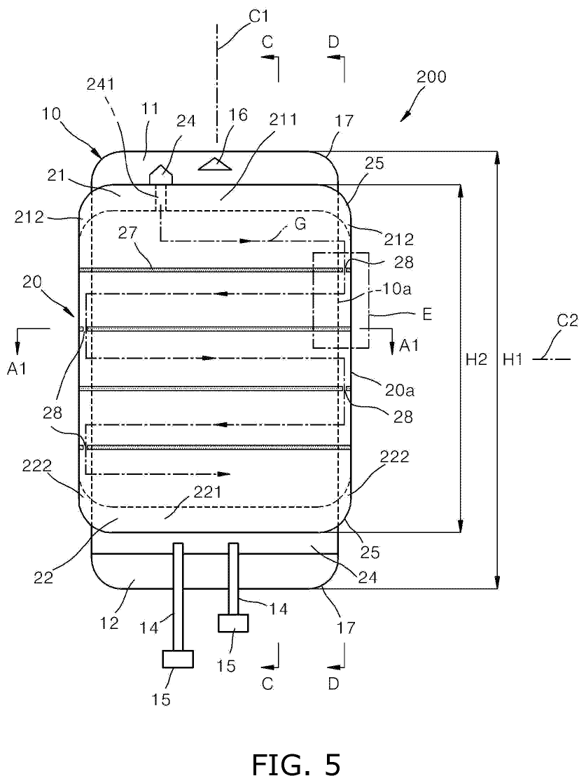

FIG. 5 is a schematic diagram of a fluid bag 200 according to another embodiment of the present invention. The fluid bag 200 is mostly the same as the above-described fluid bag 100 in terms of elements and effects and thus only differences therebetween will be described below.

In the fluid bag 200, the air storage space 23 includes a plurality of unit spaces 23a connected to each other and spatially divided by boundary lines 27.

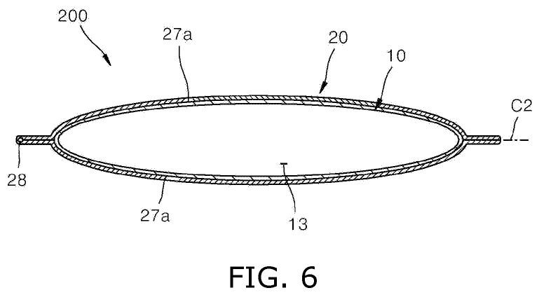

In the current embodiment, as illustrated in FIG. 6, the boundary lines 27 may be formed by bonded lines 27a along which the outer surface 18 of the main body 10 is bonded to the inner surface 26 of the pressing bag 20, or by bonded lines 27a along which front and rear surfaces of the pressing bag 20 are bonded to each other.

A shape and the number of the unit spaces 23a are determined based on a shape of the boundary lines 27.

In the current embodiment, the unit spaces 23a are spaced apart from each other by a preset distance and are arranged in a vertical direction along a virtual first central axis C1 extending from the upper end of the pressing bag 20 to the lower end of the pressing bag 20.

In the current embodiment, each of the boundary lines 27 extends in a horizontal direction along a second central axis C2 perpendicularly crossing the first central axis C1.

Therefore, the unit spaces 23a are provided as horizontal unit spaces 23a divided by the boundary lines 27 and horizontally extending along the second central axis C2.

In the current embodiment, the air inlet 24 is connected to the unit space 23a located at a top end of the pressing bag 20.

An end of each boundary line 27 is closed but, at the other end of the boundary line 27, a flow rate reducer 28 for disturbing the flow of the air G is provided.

The flow rate reducer 28 is located between neighboring unit spaces 23a to control a flow rate of the air G per unit time to be equal to or less than a preset value.

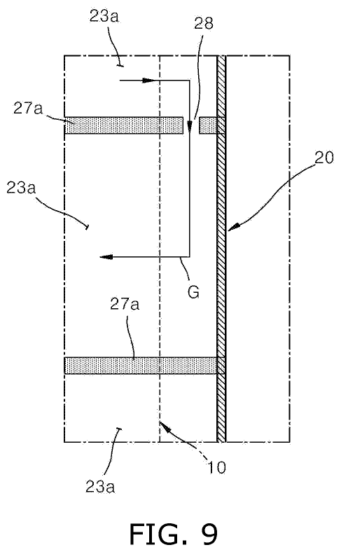

In the current embodiment, as illustrated in FIGS. 6 and 9, the flow rate reducer 28 includes a hole having a small diameter equal to or less than a preset value.

The diameter of the flow rate reducer 28 is properly selected considering a volume of the unit spaces 23a and a flow rate of the air G supplied through the air inlet 24, and may have a value from 0.0001 mm to 0.1 mm.

The flow rate reducers 28 are alternately provided at left and right ends of the boundary lines 27 as illustrated in FIG. 5, to increase a flow path of the air G in the air storage space 23. As such, the flow path of the air G in the air storage space 23 has a zigzag shape.

In the fluid bag 200, the unit spaces 23a are filled with the air G through a plurality of flow rate reducers 28 and inflate sequentially from the unit space 23a located at the upper end of the pressing bag 20 to the unit space 23a located at the lower end of the pressing bag 20.

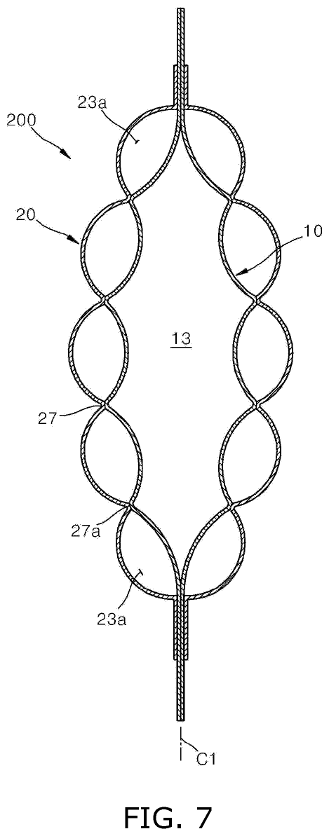

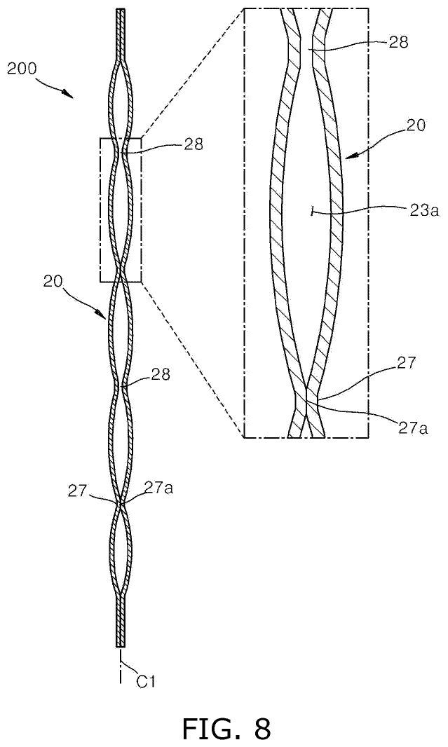

The fluid bag 200 includes the main body 10 having the fluid storage space 13 capable of containing the fluid, the air storage space 23 capable of containing the air G, and the pressing bag 20 capable of inflating to press the main body 10 when the air storage space 23 is filled with the air G, wherein the pressing bag 20 is integrally connected to the main body 10, and wherein the air storage space 23 includes one or more unit spaces 23a connected to each other and spatially divided by the boundary lines 27. Thus, unlike the fluid bag 100 illustrated in FIG. 4, when the air storage space 23 is filled with the air G, the pressing bag 20 may press the main body 10 without excessive inflation as illustrated in FIG. 7, and a risk of burst of the pressing bag 20 may be reduced. In addition, a user may not feel anxious that the pressing bag 20 would excessively inflate and burst.

In the fluid bag 200, the air storage space 23 is formed by association of the outer surface 18 of the main body 10 and the inner surface 26 of the pressing bag 20, and the boundary lines 27 are formed by bonding the outer surface 18 of the main body 10 to the inner surface 26 of the pressing bag 20. Thus, the unit spaces 23a may be easily formed.

Furthermore, in the fluid bag 200, the fluid outlet 14 connected to the fluid storage space 13 is provided at the lower end of the main body 10, the one or more unit spaces 23a are arranged from the upper end of the pressing bag 20 to the lower end of the pressing bag 20, and the unit spaces 23a are filled with the air G and inflate sequentially from the unit space 23a located at the upper end of the pressing bag 20 to the unit space 23a located at the lower end of the pressing bag 20. Thus, the main body 10 may be pressed sequentially from the upper end of the main body 10 to the lower end of the main body 10. Such an advantage is critical because the fluid stored in the fluid storage space 13 is always located near the fluid outlet 14 at the lower end of the fluid storage space 13 due to the gravity.

Besides, in the fluid bag 200, a plurality of the boundary lines 27 extend along the second central axis C2 crossing the virtual first central axis C1 extending from the upper end of the pressing bag 20 to the lower end of the pressing bag 20, and are spaced apart from each other by a preset distance and are arranged along the first central axis C1. Thus, the air storage space 23 may be easily divided and defined in a horizontal direction as illustrated in FIG. 5.

Additionally, in the fluid bag 200, the flow rate reducer 28 for disturbing the flow of the air G is provided between neighboring unit spaces 23a to control the flow rate of the air G per unit time to be equal to or less than the preset value.

Thus, the unit spaces 23a may inflate sequentially from the unit space 23a located at an end of the pressing bag 20 to the unit space 23a located at the other end of the pressing bag 20.

The air storage space 23 includes the horizontal unit spaces 23a extending in a horizontal direction along the second central axis C2 and arranged in a vertical direction along the first central axis C1 in the current embodiment, but may also include various-shaped unit spaces, e.g., vertical unit spaces extending in a vertical direction along the first central axis C1, or diagonal unit spaces extending in a direction diagonal to the first central axis C1.

The main body 10 and the pressing bag 20 are produced using polyethylene films in the afore-described embodiments, but may also be produced using other synthetic resin films.

The air storage space 23 is formed by association of the outer surface 18 of the main body 10 and the inner surface 26 of the pressing bag 20 in the afore-described embodiments, but may also be formed by only the pressing bag 20.

While the present invention has been particularly shown and described with reference to embodiments thereof, it will be understood by one of ordinary skill in the art that various changes in form and details may be made therein without departing from the spirit and scope of the present invention as defined by the following claims.

1. A fluid bag comprising:
a main body having a fluid storage space capable of containing a fluid;
an air storage space capable of containing air; and
a pressing bag capable of inflating to press the main body when the air storage space is filled with the air,
wherein the pressing bag is integrally connected to the main body, and
wherein the air storage space comprises one or more unit spaces connected to each other and spatially divided by boundary lines.

2. The fluid bag of claim 1, wherein the air storage space is formed by association of an outer surface of the main body and an inner surface of the pressing bag, and
wherein the boundary lines are formed by bonding the outer surface of the main body to the inner surface of the pressing bag.

3. The fluid bag of claim 1, wherein a fluid outlet connected to the fluid storage space is provided at a lower end of the main body,
wherein the one or more unit spaces are arranged from an upper end of the pressing bag to a lower end of the pressing bag, and
wherein the unit spaces are filled with the air and inflate sequentially from the unit space located at the upper end of the pressing bag to the unit space located at the lower end of the pressing bag.

4. The fluid bag of claim 3, wherein a plurality of the boundary lines extend along a second central axis crossing a virtual first central axis extending from the upper end of the pressing bag to the lower end of the pressing bag, and are spaced apart from each other by a preset distance and are arranged along the first central axis.

5. The fluid bag of claim 1, wherein a flow rate reducer for disturbing flow of the air is provided between neighboring unit spaces to control a flow rate of the air per unit time to be equal to or less than a preset value.
